(19) United States
(12) Patent Application Publication
(10) Pub. No.: US 2017/0108910 A1
(43) Pub. Date: Apr. 20, 2017

(54) USB CABLE

(71) Applicant: PRUFEN Pte Ltd, Singapore (SG)

(72) Inventors: Sian Ee GOH, Singapore (SG); Siang Thia GOH, Singapore (SG)

(73) Assignee: PRUFEN PTE LTD, Singapore (SG)

(21) Appl. No.: 14/892,966

(22) PCT Filed: Oct. 20, 2015
(86) PCT No.: PCT/SG2015/050401

§ 371 Date: Nov. 20, 2015

(30) Foreign Application Priority Data
Mar. 13, 2015 (SG) PCT/SG2015/000079

(51) Int. Cl. G06F 1/30; G06F 13/38; G06F 1/26

(52) U.S. Cl. CPC G06F 1/305; G06F 1/266; G06F 13/385

(57) ABSTRACT

A USB cable configured for charging a recipient device with a power source, the USB cable comprising: a first end connector for coupling with the power source, the first end connector comprising a first temperature sensor configured to obtain temperature measurements of the power source; a second end connector for coupling with the recipient device; and a controller module connected with the first end connector and the second end connector, the controller module configured to prevent current from flowing from the power source to the recipient device upon the first temperature sensor detecting an abnormally high temperature of the power source.

### FIELD OF INVENTION

The present invention relates to a USB cable, specifically, an intelligent USB cable for enhancing operational safety when charging a device with a power source using the USB cable.

### BACKGROUND

USB cables are nearly always used for connecting mobile devices during instances of charging and/or data transfer. Charging can be carried out using, for example, a PC, a charging adapter, a portable power source and the like.

USB cables are typically passive in nature with a configuration of connectors at both ends and a USB cable in between. The structure of the USB cable is typically four insulated copper wires bundled together and shielded with a braided copper exterior. This bundle is then insulated to form a single USB cable. The USB cable types are namely V_{BUS}, D+, D−, GND and SGND denoting 5V power, differential data lines, ground and shield ground respectively. In accordance with USB standards, one connector is a Series ‘A’ type while the other connector is a micro/mini USB connector. A example of a USB cable is provided by Apple Inc. having a proprietary connector that connects to mobile devices marketed by Apple Inc.

Based on USB standards, a USB cable must be able to carry 0.5 A at 5V. Ideally, this voltage should not fall below 5% of 5V under full loading of 500 mA at the device end. However, new models of mobile devices are configured to operate at higher current ratings of between 1 A to 2.1 A. Correspondingly, this leads to the gauge in the copper wires to be adjusted accordingly to ensure the operating voltage does not fall below 4.75V.

It should be evident that USB cables that are used to support older products specified at 0.5 A do not function desirably when used with a product that requires higher currents. Most product manufacturers usually bundle appropriate USB cables and/or charging apparatus to ensure proper operation of their products. The issue of incorrect USB cables being used is avoided. Unfortunately, issues arise when the appropriate USB cables and/or charging apparatus require replacement as the product manufacturers have no control over user behaviour when buying replacement USB cables, charging apparatus and even batteries. For USB devices without intelligence to adjust power consumption to maintain >4.75V operation, there is a danger of overloading the USB power source.

USB cables and/or charging apparatus purchased from the branded product companies are more expensive compared to OEM types. The price difference can be substantial. Given the ready availability of OEM USB cables and charging apparatus, many users do not buy replacements from the branded product companies. Unfortunately, given that the OEM types are usually provided in packaging which are not labelled with any technical parameters of the contents, the users do not know if their purchase is appropriate for the mobile devices which they own. Moreover, the users generally do not understand the safety risks of using the OEM types and typical USB cables are unable to trigger a safely stop operation when if it is operating outside its electrical design limits.

Some of the issues which arise due to usage of inappropriate USB cables and/or charging apparatus are as follows:

### a) Burnt Charging Apparatus and Live Voltage Leakage

Referring to FIG. 1 (prior art), there is shown a charging apparatus which has undergone burning. There is nothing to prevent the user from connecting any USB cable that has the USB connector to a common USB port receptacle at the charging apparatus. An under-rated charging apparatus will overheat and over prolonged use will become faulty. The consequence of overheating at the charging apparatus may not only be burnt parts but also live voltage leak after some of the components are damaged. The live voltage can leak into the USB cable and potentially result in electrocution of the user.

### b) Charging Apparatus Causes a Long Duration to Charge Mobile Device

This happens when the charging apparatus is under-rated such that it cannot provide current that it is being rated to deliver. For example, a 0.5 A at 5V charging apparatus cannot maintain its voltage at 4.75V when 500 mA is drawn.

### c) USB Cable Causes a Long Duration to Charge Mobile Device

Charging takes a long time because the wire gauge in a long USB cable is incorrect. Essentially there is insufficient copper resulting is USB cable resistance causing significant losses during the charging process. For example, at higher current charging of >1 A, the 5V voltage drop becomes significant when it reaches the mobile device end of the USB cable. Intelligent mobile devices are forced to reduce loading to maintain >4.75 v operation. This means a lower current to charge the mobile device, leading to longer charging time.

### d) Short Circuiting of USB Cable Connector

The connector contacts get shorted due to quality issues or if an external conductive material gets into the Micro USB or the Apple 30 pin connector. There may be situations that this material causes the 5V and Ground contacts to be shorted. This will result in either the 30 pin connector over-heating and self-combusting while connected to the mobile device as shown in FIG. 2 (prior art.

Furthermore, other issues can also arise due to incorrect usage of USB cables, for instance, when the USB cable is twisted excessively as shown in FIG. 3 (prior art), the 5V and ground wires of the USB cable gets shorted which will result in possible damage to the charging apparatus and overheating at a location of the short.

### SUMMARY

The USB cable is configured to connect a device with a power source and is able to detect any abnormally high temperature at the power source side or the device side of the USB cable during charging of the device process and to alert a user that there is an abnormally high temperature situation detected, as well as to terminate flow of current from the power source to the device. The USB cable is also able to measure and assess if the voltage and current during charging are within a safe operating zone, and if there is an abnormal situation, it will safely suspend power to prevent further deterioration of either or both the power source and the recipient device.

In addition to intelligently suspending power to the recipient device, the USB cable is preferably also able to alert the user by way of a display, LED lights and/or buzzer to the potentially hazardous situation.

The USB cable is further able to store energy consumed in a charging session and the last known I,V,C during a fault to ROM (implemented with FRAM or EEPROM etc.) of a controller module provided in the USB cable.

The USB cable is preferably also able to assess if the power source can meet the rated current like 0.5 A, 1.0 A or 2.1 A by way of a programmable active load circuit and consequently to allow or disallow the recipient device to receive power.

The desired end result is a USB charging/data USB cable that is able to provide the user with an added level of protection from potentially hazardous situation, while indicating temperature and status of operation via an LCD or OLED display during operation under normal temperature conditions.

According to a first aspect, there is provided a USB cable configured for charging a recipient device with a power source, the USB cable comprising: a first end connector for coupling with the power source, the first end connector comprising a first temperature sensor configured to obtain temperature measurements of the power source; a second end connector for coupling with the recipient device; and a controller module connected with the first end connector and the second end connector, the controller module configured to prevent current from flowing from the power source to the recipient device upon the first temperature sensor detecting an abnormally high temperature of the power source.

The second end connector may comprise a second temperature sensor configured to obtain temperature measurements of the recipient device, the controller module further configured to prevent current from flowing from the power source to the recipient device upon the second temperature sensor detecting an abnormally high temperature of the recipient device.

The first temperature sensor may be connected to the controller module via an electromagnetic interference (EMI) shield provided along wiring of the USB cable.

The second temperature sensor may be connected to the controller module via the electromagnetic interference (EMI) shield provided along wiring of the USB cable.

The EMI shield may be connected to a coupling capacitor at the controller module, wherein the EMI shield is connected to a coupling capacitor at the first end connector and wherein the EMI shield is connected to a coupling capacitor at the second end connector to conduct EMI signals.

The first temperature sensor may be provided within a plastic insulator of the first end connector and on a metal connector of the first end connector.

The second temperature sensor may be provided within a plastic insulator of the second end connector and on a metal connector of the second end connector.

The controller module may be further configured to store data in Flash memory provided in the controller module.

The controller module may comprise a power switch configured to be turned off to prevent current from flowing from the power source to the recipient device upon detecting the abnormally high temperature.

The power switch may be further configured to be turned off to prevent current from flowing from the power source to the recipient device upon operating voltage of the USB cable falling below a normal operating voltage range of the USB cable.

The first temperature sensor may be connected to a ground connection provided at the first end connector.

The second temperature sensor may be connected to a ground connection provided at the second end connector.

The controller module may be configured to display temperature and status of operation of the USB cable under normal temperature conditions of the USB cable and to provide an early warning alert when temperature detected by the first temperature sensor is near abnormal.

The controller module may be further configured to display temperature and status of operation of the USB cable under normal temperature conditions of the USB cable and to provide an early warning alert when temperature detected by the second temperature sensor is near abnormal.

### DESCRIPTION OF FIGURES

In order that the present invention may be fully understood and readily put into practical effect, there shall now be described by way of non-limitative example only preferred embodiments, the description being with reference to the accompanying illustrative figures.

FIG. 1 (prior art) is a photograph of a damaged charging apparatus.

FIG. 2 (prior art) is a photograph of a damaged connector at a device end.

FIG. 3 (prior art) is a photograph of a twisted USB cable.

FIG. 4 is a top view and a side view of an embodiment of a USB cable of the present application.

FIG. 5 is exemplary representations of a display of an embodiment of the USB cable during use.

FIG. 6(a) is a first exemplary block diagram of hardware implementation of a preferred embodiment of the USB cable.

FIG. 6(b) is a second exemplary block diagram of hardware implementation of a preferred embodiment of the USB cable.

FIG. 7(a) is a schematic illustration of an exemplary end connector of the USB cable configured for connection with a power source.

FIG. 7(b) is a schematic illustration of an exemplary end connector of the USB cable configured for connection with a recipient device.

FIG. 8 is a schematic illustration of a temperature sensor of the USB cable connected via EMI shielding of the USB cable to a controller module of the USB cable.

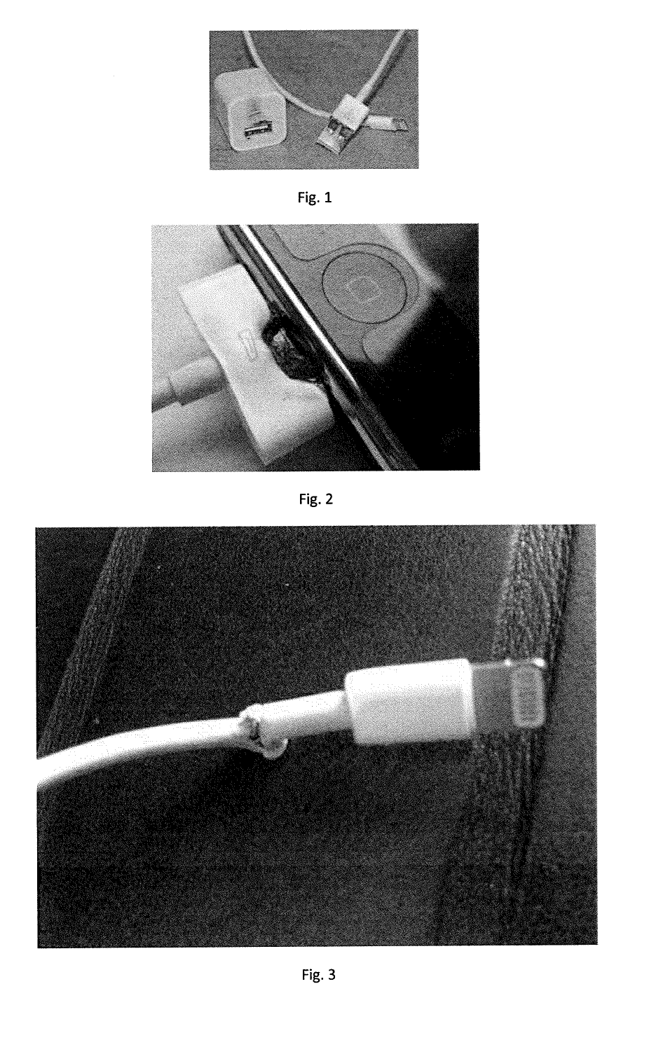

### DESCRIPTION OF PREFERRED EMBODIMENTS

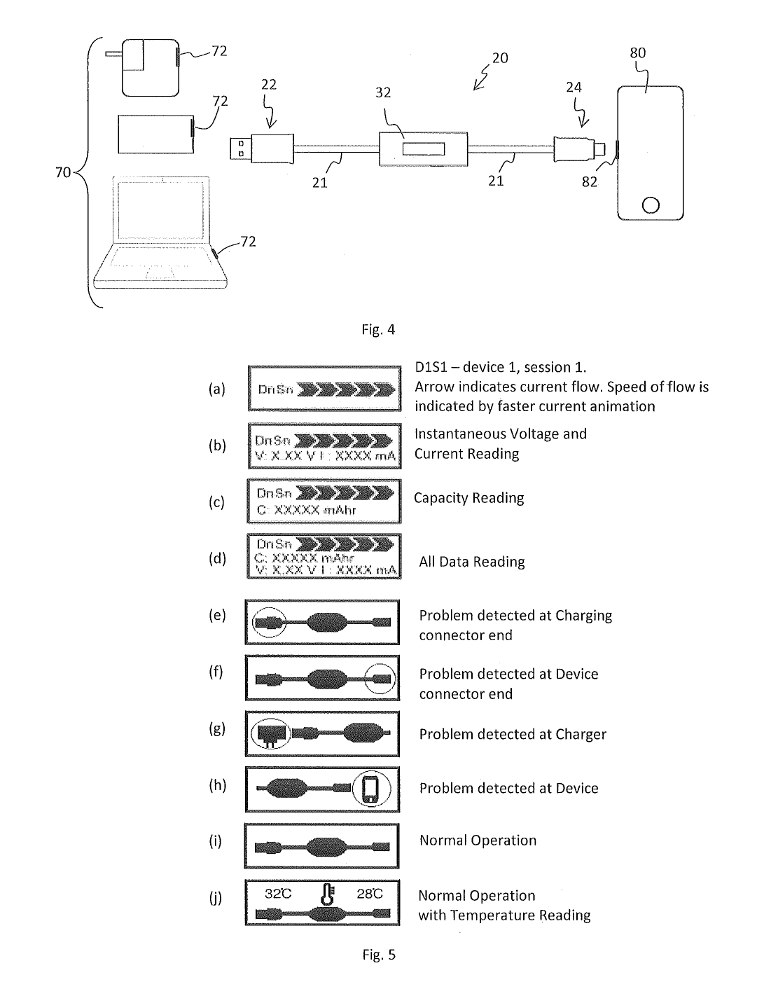

Exemplary embodiments of the USB cable 20 will be described with reference to FIGS. 4 to 8 in which the same reference numerals are used to denote the same or similar parts.

FIG. 4 shows an exemplary embodiment of the USB cable 20. The USB 20 comprises wiring 21 having a wire gauge specified to allow high current flow, for instance, the voltage drop is specified to be not more than 5% of 5V even at 2.1 A. The USB cable 20 will allow a recipient device 80 to be charged at 2.1 A or more.

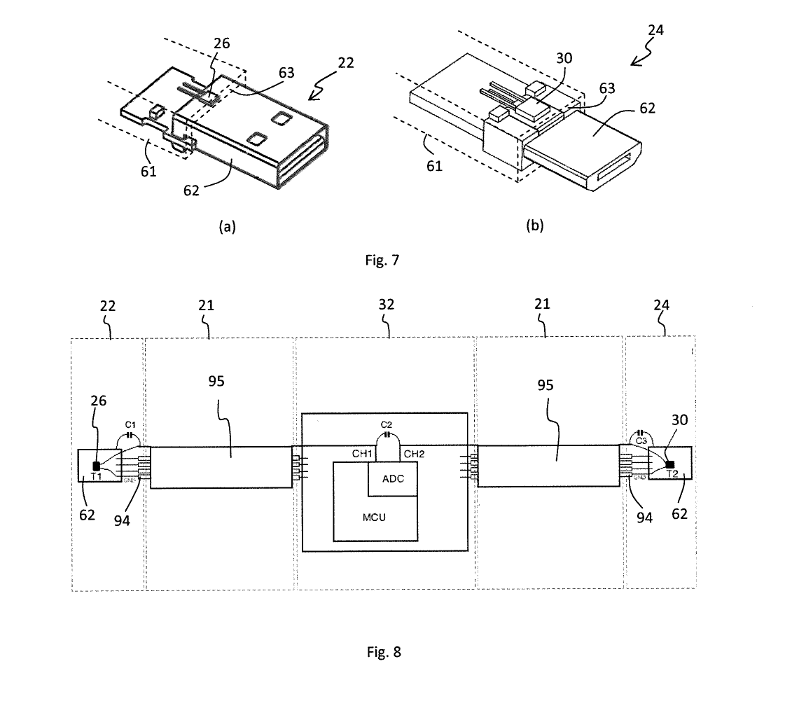

The USB cable 20 comprises a first end connector 22 for coupling with a power source 70. The first end connector 22 can be a USB-A connector and includes a first thermistor 26 as shown in FIG. 7(a). The power source 70 can include, for example, a PC, a charging adapter, a portable power source and the like. The USB cable 20 also comprises a second end connector 24 for coupling with a recipient device 80. The second end connector 24 can be, for example, mini-USB variants, micro-USB variants, lightning connector variants and so forth. The second end connector 24 can also include a thermistor 30 as shown in FIG. 7(b).

In addition, the USB cable 20 also comprises a controller module 32 communicatively connected with the first end connector 22 and the second end connector 24. The controller module 32 comprises at least one of: a low dropout regulator 34, a power switch 52, a microcontroller (MCU) 36, a USB interface 38, and an analog-digital converter 40. As connectivity of the controller module 32 to a PC is optional, it should be appreciated that the USB interface 38 is not mandatory. The controller module 32 further comprises a micro-USB receptacle 42 to enable a PC to access live data (e.g. I, V, mAhr, mWhr) from the controller module 32. The ROM in the controller module 32 is configured to store data of usage parameters during use of the USB cable 20. The amount of energy delivered for each session of charging is also recorded in ROM. In this application, ROM is used to refer to both EEPROM or FRAM. The data e.g. mAhr/mWhr collected by the USB cable 20 can be used by the user to determine if the abnormal situation has occurred by comparing with historical consumption results. Depending on the result, the user can determine if the battery capacity of the recipient device is decreasing or has become abnormal. Corrective action can subsequently be taken by the user.

Moreover, the controller module 32 may further comprise at least one of: a buzzer 44, a display 46 and a plurality of switches 48. The display 46 can be, for example, a LCD panel, an OLED panel, and the like. The plurality of switches 48 can include a “Select” and a “Mode” switch, whereby the “Select” switch is used to scroll through a list of pre-set recipient devices and the “Mode” switch is used to select a type of content shown on the display 46. The type of content is shown in FIG. 5(a)-5(d).

The USB cable 20 also comprises a power switch 52 electrically connected to the controller module 32 and a current shunt 50 electrically connected with the first end connector 22, the second end connector 24 and the controller module 32. The power switch 52 can be implemented discretely using a MOSFET and MOSFET driver or a single load switch. The purpose of the power switch 52 is to act as a switch to turn-off power supplied to the recipient device. The power isolation to the device is for safety, such as when the recipient device 80 is drawing more than the rate current. In addition, the power isolation will enable the determination of incoming power to ensure the charging apparatus meets a rated current requirement.

Finally, the USB cable 20 also comprises an adjustable active load 54 communicatively connected with the controller module 32. As mentioned in the preceding paragraph, in order to determine if the charging apparatus performs around the rated current, the adjustable active load 54 is necessary. Depending on a set-point for the rated current, the USB cable 20 will configure the active load to draw current as per the registered set-point. The measured voltage at the power rail under load will be sampled and compared against a reference threshold to determine if the charging apparatus can meet the rated current. In addition, due to the generation of heat, a duration of test at full rated current is not excessive to prevent generation of excessive heat which causes failure of components or enclosure.

It should be appreciated that the controller module 32 includes at least one receptacle to house trailing cable portions of the first end connector 22 and the second end connector 24 as shown in the side view of the USB cable 20.

Referring to FIG. 5, there are shown exemplary screens appearing on the display 46 of the USB cable 20 during operation of the USB cable 20. FIG. 5(a) shows animated arrows when the recipient device is connected and undergoing charging, whereby a higher rate of current flow is denoted by faster animation of the arrows. The speed of charging can be shown using moving arrow heads in a row to denote a fraction of the 1 mAhr count. However, since showing the 1 mAhr count directly will be very slow, the effect of flow can be visually enhanced by using 1/10th of a mAhr count. FIG. 5(b) also shows animated arrows when the recipient device is connected and undergoing charging, together with instantaneous voltage and current readings. FIG. 5(c) also shows animated arrows when the recipient device is connected and undergoing charging, together with a capacity reading of a battery of the recipient device. Finally, FIG. 5(d) also shows animated arrows when the recipient device is connected and undergoing charging, together with capacity of a battery of the recipient device, instantaneous voltage and current readings. Other detailed data e.g. V, mA, mW, mAhr, mWhr, speed of charging, temperature, voltage drop below specified threshold loading, over temperature, over current, over voltage and so forth can also be shown. It should be appreciated that the various sample screens can be viewable by toggling the “Mode” switch of the USB cable 20. In addition, the “Select” switch is used to select the recipient device by pressing and releasing.

When issues are detected by the USB cable 20, the display 46 of the USB cable 20 is also configured to provide an indication to the user. FIG. 5(e) shows an issue detected at the first end connector 22. FIG. 5(f) shows an issue detected at the second end connector 24. FIG. 5(g) shows an issue detected at the charging apparatus. FIG. 5(h) shows an issue detected at the recipient device. FIG. 5(i) shows no current issues. FIG. 5(j) shows normal operation with temperature measurements at the first and second end connectors 22, 24. Once an issue is detected by the USB cable 20, the process of charging is stopped. This is carried out by de-activating the MOSFET 52. Alternatively, a relay switch can also be used in place of the MOSFET 52. The buzzer 44 may be triggered to alert the user of the detected issue. To use the USB cable 20 again, the user needs to disconnect the first end connector 22 and re-couple with the charging apparatus. The USB cable 20 is powered by the power source 70 and once an issue is detected, the USB cable 20 de-activates the MOSFET 52 (or relay switch) and provides an indication to the user with the display 46 and/or the buzzer 44. This no-charging state will remain until intervention by the user, for example, removal of the first end connector 22 and reinsertion into the power source. Disconnecting and reconnecting at the power source 70 end is preferably the only way to reset the no-charging state to a ready state to start a qualification (in order to indicate the appropriate information on the display 46 and charging process.

Even though the display 46 is configured to provide an indication to the user, the USB cable 20 can further include an LED 47 configured to indicate a status of the charging. The use of the LED 47 will enable the user to determine the status of the charging from a distance. The LED 47 can either be placed at a same side as the display 46 or at any part of the USB cable 20 containing the controller module 32.

It should be noted that the USB cable 20 also determines if it is allowed to deliver current to the recipient device. The USB cable 20 determines parameters such as, for example, incoming voltage, incoming maximum current, temperature at connectors 22, 24 and so forth. These parameters are periodically monitored at a pre-determined time interval and any anomaly beyond a predetermined threshold will result in the USB cable 20 stopping further current flowing to the recipient device. All faults are logged for review by the user. As a result of this feature, the charger apparatus will not operate outside their rated operation as defined by the user to the USB cable or as per the default setting from factory.

Based on the description in the preceding paragraphs, it should be appreciated that the USB cable 20 brings about many benefits and advantages to the user. The benefits and advantages include:

i) Indication on the USB cable that the operation is optimal or not.
ii) Indication on the USB cable of the temperature of the power source and the temperature of the recipient device.
iii) Indication of the speed of charging/current flowing.
iv) Indication of charge count in mAhr or mWhr with high sensitivity by introducing units of count below 1 mAhr or 1 mWhr.
v) Reduction of probability of electrocution.
vi) Reduction in instances of damage to recipient device.
vii) Checking of battery capacity of recipient device.
viii) Checking of charging apparatus.
ix) Detection of connector issues.
x) Possibility to carry out a detailed analysis of the charging process.

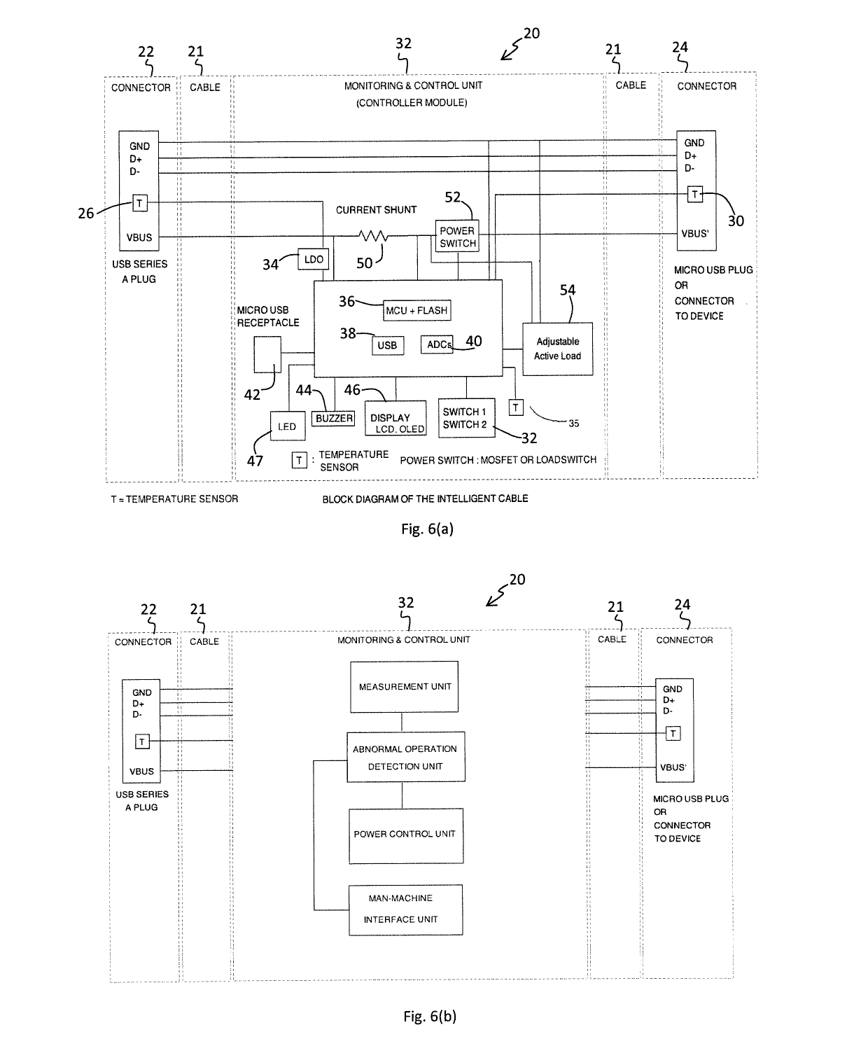

Exemplary block diagrams of hardware implementation of the preferred embodiment of the USB cable 20 are shown in FIGS. 6(a) and (b). In the preferred embodiment, the USB cable 20 is configured to connect a recipient device 80 with a power source 70 and is able to detect any abnormally high temperature at the power source side 22 or the device side 24 of the USB cable 20 during the process of charging the recipient device 80. Upon detecting the abnormally high temperature, the USB cable 20 is configured to alert a user that there is an abnormally high temperature situation detected, as well as to terminate flow of current from the power source 70 to the recipient device 80. The desired end result is a USB charging/data USB cable 20 that is able to provide the user with an added level of protection from a potentially hazardous situation, while indicating temperature and status of operation via an LCD or OLED display during operation under normal temperature conditions.

In order to achieve the above functions, the USB cable 20 is configured to be able to accurately measure temperature of at least the power source or adaptor 70 and preferably also the recipient device 80 to which the USB cable 20 is connected. Accordingly, each of the first end connector 22 and the second end connector 24 of the USB cable 20 is provided with a first and second temperature sensor 26, 30 respectively, as shown in FIGS. 7(a) and (b). An example of temperature sensors suitable for use as the first and second temperatures sensors 26, 30 is the NTC thermistor or the like. The first and second end connectors 22, 24 of the USB cable 20 each typically comprises a plastic insulator 61 (depicted in dotted lines for clarity) that houses a metal connector 62 that extends beyond a free edge 63 of the plastic insulator 61. The tubular metal connector 62 is configured for coupling with a metallic receptacle 72 of the power source/adaptor 70 or a receptacle 82 of the recipient device 80 accordingly. The receptacle 72, 82 typically has four metal sides (not shown) for forming an electrical connection with the metal connector 62 of the end connector 22, 24.

The first and second temperature sensors 26, 30 are positioned in the first and second end connectors 22, 24 within the plastic insulator 61 in order to protect them from harmful environmental exposure and mechanical damage. The temperature sensors 26, 30 should be provided on the metal connector 62 and preferably adjacent the free edge 63 of the plastic insulator 61, as shown in FIG. 7(a), so as to be in closest possible proximity with their respective receptacles 72, 82 when connected, in order to obtain accurate temperature measurements of the power adaptor 70 and of the recipient device 80 at each of the first and second end connectors 22, 24 of the USB cable 20 respectively.

Locating the temperature sensors 26, 30 in the first and second end connectors 22, 24 so that the temperature sensors 26, 30 are as close as possible to the metallic receptacle 72 or 82 of the power source 70 and the recipient device 80 respectively when connected is crucial to optimal functioning of the USB cable 20. This ensures earliest possible detection of temperature of the power source 70 and the recipient device 80, and also ensures that when the USB cable 20 is unplugged, residual temperature will be restored to ambient temperature more quickly.

Detection of an abnormally high temperature by one or both of the first and second temperature sensors 26, 30 is considered an issue that will be alerted to the user using the electronic circuit comprising the controller module 32, the display 46 and/or the buzzer 44 as described above, as well as to terminate flow of current from the power source 70 to the recipient device 80. Notably, the controller module 32 is connected to each of the temperature sensors 26, 30 via an ADC (analog-to-digital converter) or serial I/O (input/output) interface, depending on whether the first and second temperature sensors 26, 30 use analog or digital methods to read temperature.

Detection of an abnormally high temperature may be achieved by the controller module 32 being preprogrammed with a predetermined threshold temperature for each of the first and second end connectors 22, 24, such that when one or both of the first and second temperature sensors 26, 30 measures a temperature that is higher than their respective predetermined threshold temperatures, the controller module 32 determines that an abnormally high temperature has been detected and accordingly alerts the user as described above, as well as terminates flow of current from the power source 70 to the recipient device 80.

In addition to the controller module 32 alerting a user and terminating flow of current from the power source 70 to the recipient device when an abnormally high temperature has been detected, the controller module 32 is preferably also configured to display temperature and status of operation of the USB cable under normal temperature conditions of the USB cable. The controller module 32 is preferably also further configured to provide an early warning alert when temperature detected by one or both of the first and second temperature sensors 26, 30 is near abnormal. A near abnormal temperature may be determined as being within a predetermined difference from the predetermined threshold temperatures.

Preferably, the controller module 32 is configured to store data in its Flash memory that can be written and read, using Electrically Erasable Programmable Read-Only Memory (EEPROM) or Ferroelectric RAM (FRAM), for example. Data stored by the controller module 32 may include temperature data measured by the first and second temperature sensors 26, 30 as well as computed data such as I, V, mAhr, mWhr as mentioned above.

As mentioned above, the USB cable 20 is configured to terminate current flow from the power source/adaptor 70 to the recipient device 80 upon detection of an abnormally high temperature. To do so, a power switch 52 in the controller module 32 such as a MOSFET or a load switch 52 described above is configured to be turned on during normal operation and to be turned off by the firmware upon detection of the abnormally high temperature by either of the two temperature sensors 26, 30 to prevent current from flowing from the power source 70 to the recipient device 80.

In order to implement the first and second temperature sensors 26, 30 at each of the first and second end connectors 22, 24 respectively, each temperature sensor 26, 30 needs to be connected to ground as well as connected to the ADC or I/O (input/output) interface at the controller module 32. As mentioned above, the USB cable 20 as a USB cable comprises discrete wiring for each of the D+, D−, Vbus and ground 94 connections, as shown in FIG. 8, as well as the braided copper EMI (electromagnetic interference) shield 95.

In the present invention, no additional wiring along the length of the USB cable 20 is required for connecting the first and second temperature sensors 26, 30 to the controller module 32. Instead, each of the temperature sensors 26, 30 is connected to the ADC or I/O interface of the controller module 32 via the EMI shield 95 and connected to ground 94 at each of the end connectors 22, 24 of the USB cable 20. FIG. 8 shows the first and second end connectors 22, 24 and temperature sensors 26, 30 connected this way to the controller module 32. The EMI shield 95 is thus used to provide EMI shielding as well as signal transference from the first and second temperature sensors 26, 30. In this way, the USB cable 20 is kept flexible without requiring additional wiring that would add undesirable additional stiffness, weight, and cost to the USB cable 20. Notably, the EMI shield 95 is connected to a coupling capacitor C2 provided at the controller module 32 and a coupling capacitor C1, C3 provided at each of the end connectors 22, 24 respectively to conduct EMI signals to the shield ground pin of the USB connectors, as shown in FIG. 9.

To further enhance safe operation of the USB cable 20, the USB cable 20 may be further configured such that the load switch 52 is turned off when operating voltage of the USB cable 20 falls below 4.5 V or the normal operating voltage range of the USB cable 20 during use of the USB cable 20 for charging the recipient device 80 using the power source 70. This is to guard against an under-voltage situation, where the operating voltage falls below that of the normal USB operating voltage range of the USB cable 20 which normally ranges from 4.75V to 5.25V. In an under-voltage situation, the Vbus voltage drop during charging using the USB cable 20 can mean that there is a large current draw at the recipient device 80 side. This can be due to the power source 70 being unable to maintain the current requirements of the recipient device 80 or that the recipient device 80 is abnormally drawing too much current. In both cases, heat is likely to be generated if the under-voltage situation is allowed to be prolonged. Thus, as a safety measure, the USB cable 20 may be further configured to cut off power supply to the recipient device 80 by switching off the power switch 52 upon the voltage falling below 4.5V.

Whilst there have been described in the foregoing description preferred embodiments, it will be understood by those skilled in the technology concerned that many variations or modifications in details of design or construction may be made without departing from the present invention. For example, while it has been described that the USB cable has two temperature sensors—one at each of the two end connectors 22, 24, other embodiments of the USB cable may be provided in which only the first end connector 22 for coupling with the power source 70 is provided with a temperature sensor.

1. A USB cable configured for charging a recipient device with a power source, the USB cable comprising:
a first end connector for coupling with the power source, the first end connector comprising a first temperature sensor configured to obtain temperature measurements of the power source;
a second end connector for coupling with the recipient device; and
a controller module connected with the first end connector and the second end connector, the controller module configured to prevent current from flowing from the power source to the recipient device upon the first temperature sensor detecting an abnormally high temperature of the power source.

2. The USB cable of claim 1, wherein the second end connector comprises a second temperature sensor configured to obtain temperature measurements of the recipient device, the controller module further configured to prevent current from flowing from the power source to the recipient device upon the second temperature sensor detecting an abnormally high temperature of the recipient device.

3. The USB cable of claim 1, wherein the first temperature sensor is connected to the controller module via an electromagnetic interference (EMI) shield provided along wiring of the USB cable.

4. The USB cable of claim 2, wherein the second temperature sensor is connected to the controller module via the electromagnetic interference (EMI) shield provided along wiring of the USB cable.

5. The USB cable of claim 4, wherein the EMI shield is connected to a coupling capacitor at the controller module, wherein the EMI shield is connected to a coupling capacitor at the first end connector and wherein the EMI shield is connected to a coupling capacitor at the second end connector to conduct EMI signals.

6. The USB cable of claim 1, wherein the first temperature sensor is provided within a plastic insulator of the first end connector and on a metal connector of the first end connector.

7. The USB cable of claim 2, wherein the second temperature sensor is provided within a plastic insulator of the second end connector and on a metal connector of the second end connector.

8. The USB cable of claim 1, wherein the controller module is further configured to store data in Flash memory provided in the controller module.

9. The USB cable of claim 1, wherein the controller module comprises a power switch configured to be turned off to prevent current from flowing from the power source to the recipient device upon detecting the abnormally high temperature.

10. The USB cable of claim 1, wherein the power switch is further configured to be turned off to prevent current from flowing from the power source to the recipient device upon operating voltage of the USB cable falling below a normal operating voltage range of the USB cable.

11. The USB cable of claim 1, wherein the first temperature sensor is connected to a ground connection provided at the first end connector.

12. The USB cable of claim 2, wherein the second temperature sensor is connected to a ground connection provided at the second end connector.

13. The USB cable of claim 1, wherein the controller module is configured to display temperature and status of operation of the USB cable under normal temperature conditions of the USB cable and to provide an early warning alert when temperature detected by the first temperature sensor is near abnormal.

14. The USB cable of claim 2, wherein the controller module is further configured to display temperature and status of operation of the USB cable under normal temperature conditions of the USB cable and to provide an early warning alert when temperature detected by the second temperature sensor is near abnormal.

15. The USB cable of claim 1, wherein the controller module is further configured to display current, voltage, and mAhr during charging.

16. The USB cable of claim 2, wherein the controller module is further configured to display current, voltage, and mAhr during charging.
